(19) United States
(12) Patent Application Publication
(10) Pub. No.: US 2015/0275013 A1
(43) Pub. Date: Oct. 1, 2015

(54) INK SET AND LIQUID EJECTING HEAD

(71) Applicant: Seiko Epson Corporation, Tokyo (JP)

(72) Inventors: Tomohiro ARUGA, Matsumoto (JP); Ayako NISHIKI, Matsumoto (JP); Hiroaki KUMETA, Matsumoto (JP)

(21) Appl. No.: 14/667,983

(22) Filed: Mar. 25, 2015

(30) Foreign Application Priority Data
Mar. 26, 2014 (JP) 2014-063298

(51) Int. Cl. C09D 11/40; C09D 11/38; C09D 11/322

(52) U.S. Cl. CPC C09D 11/40; C09D 11/322; C09D 11/38

(57) ABSTRACT

An ink set according to the invention includes a yellow ink, a magenta ink, and a cyan ink, in which each of the inks contains a coloring agent which includes water and a pigment, the coloring agent of the magenta ink and the cyan ink is a first coloring agent which has a phosphorus-containing group on a surface of the pigment, the coloring agent of the yellow ink is a second coloring agent where a surface of the pigment is covered by a styrene-acryl resin, and each of the inks contains 50 mass % or more to 60 mass % or less of water with respect to the total mass of the ink.

### BACKGROUND

1. Technical Field

The present invention relates to an ink set which is provided with a yellow ink, a magenta ink, and a cyan ink and a liquid ejecting head which is suitable for the ink set.

2. Related Art

Dyes or pigments are used for coloring materials of each ink of an ink set for ink jet recording. In general, it is known that dyes are superior to pigments in terms of coloring properties or color reproducibility and that pigments are superior to dyes in terms of light resistance, water resistance, and ozone resistance.

In a case of performing ink jet recording using a pigment-based ink set in the related art, with regard to secondary colors such as magenta, cyan, and green, there is a tendency for problems to easily occur with the coloring properties or color reproducibility and for images to become dull.

As a solution to such a problem, an ink set was proposed which is configured from a first ink which contains a self-dispersing pigment where an ionizable group is chemically bonded with a surface of pigment particles and a second ink which contains a specific dye (refer to JP-A-2012-193308). According to the technique described in JP-A-2012-193308, it is possible to improve the coloring properties or color reproducibility of a secondary color image to be recorded by using both the first ink and the second ink.

In addition, an ink was proposed which contains a self-dispersing pigment where a functional group which includes a phosphonic acid group is bonded with a surface of a pigment; salt; and a water-soluble organic solvent (refer to JP-A-2012-102213). In the technique described in JP-A-2012-102213, it is possible to record an image with a high image density and an excellent water resistance or marker resistance by setting counter ions of a phosphonic acid group as lithium ions or sodium ions.

However, even when using the techniques described in JP-A-2012-193308 or JP-A-2012-102213, there are cases where it is not possible to obtain sufficient coloring properties or color reproducibility for secondary colors on a recording medium (in particular, plain paper).

In addition, in a case of using an aqueous pigment ink, since bleeding on plain paper is not sufficiently suppressed and the plain paper is dried in a state in which pressure is applied when being manufactured, there is a problem in that curling easily occurs by hydrogen bonds between the plain paper fibers being cut when water is attached. Furthermore, in a case of using an aqueous pigment ink as an ink jet ink, clogging recoverability in a recording head is also an important function.

### SUMMARY

An advantage of some aspects of the invention is to provide an ink set where the coloring properties and color reproducibility of a secondary color image on a recording medium (in particular, plain paper) are favorable, which suppresses color bleeding or curling, and where the clogging recoverability of a recording head is favorable, and a liquid ejecting head which is suitable for the ink set by solving at least a portion of the problem described above.

The invention can be realized in the following forms or application examples.

### Application Example 1

According to an aspect of the invention, there is provided an ink set including a yellow ink, a magenta ink, and a cyan ink, in which each of the inks contains a coloring agent which includes water and a pigment, the coloring agent of the magenta ink and the cyan ink is a first coloring agent which has a phosphorus-containing group on a surface of the pigment, the coloring agent of the yellow ink is a second coloring agent where a surface of the pigment is covered by a styrene-acryl resin, and each of the inks contains 50 mass % or more to 60 mass % or less of water with respect to the total mass of the ink.

According to the ink set of Application Example 1, since water which is included in the yellow ink elutes polyvalent metal ions which are included in a recording medium, the polyvalent metal ions in the recording medium and the phosphorus-containing group on the surface of the magenta ink and/or the cyan ink enter a state of easily reacting with each other and the coloring properties and color reproducibility of secondary colors are improved. In addition, by the ink set having the configuration described above, color bleeding or curling is suppressed and the clogging recoverability of a recording head is also favorable.

### Application Example 2

In the ink set of Application Example 1, a content of the pigment of the coloring agent of each of the inks in the ink set may satisfy a relationship of 9 mass %≧magenta ink>yellow ink≧cyan ink≧5 mass %.

According to the ink set of Application Example 2, the coloring properties and color reproducibility of secondary colors are improved, particularly in the red direction.

### Application Example 3

In the ink set of Application Example 1 or 2, the pigment which is contained in the yellow ink may be C.I. Pigment Yellow 74, the pigment which is contained in the magenta ink may be a solid solution of C.I. Pigment Violet 19 and a C.I. Pigment Red 202, and the pigment which is contained in the cyan ink may be C.I. Pigment Blue 15:3 or C.I. Pigment Blue 15:4.

According to the ink set of Application Example 3, the color gamut which is able to be expressed has a wide range and the coloring properties and color reproducibility of secondary colors are further improved.

### Application Example 4

In the ink set of any one of Application Examples 1 to 3, each of the inks in the ink set may further contain 0.5 mass % or more to 5 mass % or less of at least one type of water-soluble organic solvent, which is selected from a group formed of 1,2-alkanediol and glycol ether.

According to the ink set of Application Example 4, color bleeding or curling is effectively suppressed and the clogging recoverability of a recording head is also more favorable.

### Application Example 5

In the ink set of any one of Application Examples 1 to 4, each of the inks in the ink set may further contain a first surfactant where an HLB value is 8 or greater and a second surfactant where an HLB value is less than 8.

### Application Example 6

In the ink set of Application Example 5, the first surfactant may be an alkylene oxide adduct of acetylene glycol where a number of carbon atoms of a main chain is 12 or greater, the second surfactant may be acetylene glycol where a number of carbon atoms of a main chain is 10 or greater, and each of the inks in the ink set may contain 0.1 mass % or more to 1.0 mass % or less of each of the first surfactant and the second surfactant.

According to the ink set of Application Example 5 or 6, since it is possible to evenly spread inks on a recording medium, high definition images where color bleeding is reduced are easily obtained. In addition, since it is possible to suppress the generation of bubbles, the continuous discharge stability is favorable.

### Application Example 7

According to another aspect of a liquid ejecting head of the present invention, there is provided a liquid ejecting head including a nozzle row for ejecting each of the inks in the ink set according to any one example of Application Example 1 to Application Example 6, in which a nozzle row for ejecting a yellow ink is arranged on an upstream side of nozzle rows for ejecting a magenta ink and a cyan ink.

According to the liquid ejecting head of Application Example 7, by the nozzle row for ejecting a yellow ink being arranged on the upstream side, a magenta ink and/or a cyan ink is ejected onto the recording medium after the yellow ink is ejected onto a recording medium in a case of forming secondary colors. By doing so, since moisture which is included in a yellow ink elutes polyvalent metal ions which are included in a recording medium, the polyvalent metal ions in the recording medium and a phosphorus-containing group on the surface of the magenta ink and/or the cyan ink enter a state of easily reacting with each other and the coloring properties and color reproducibility of secondary colors are improved.

### BRIEF DESCRIPTION OF THE DRAWINGS

The invention will be described with reference to the accompanying drawings, wherein like numbers reference like elements.

FIG. 1 is an explanatory diagram where a serial type liquid ejecting head according to the present embodiment is viewed from a nozzle surface.

FIG. 2 is an explanatory diagram where a line type liquid ejecting head according to the present embodiment is viewed from a nozzle surface.

### DESCRIPTION OF EXEMPLARY EMBODIMENTS

Description will be given below of favorable embodiments of the present invention. The embodiments which will be described below describe one example of the present invention. In addition, the invention is not limited to the embodiments below and includes various types of modification examples which are carried out within a range which does not change the gist of the invention.

### 1. Ink Set

The ink set according to the present embodiment is provided with a yellow ink, a magenta ink, and a cyan ink, in which each of the inks contains a coloring agent which includes water and a pigment, the coloring agent of the magenta ink and the cyan ink is a first coloring agent which has a phosphorus-containing group on a surface of the pigment, the coloring agent of the yellow ink is a second coloring agent where a surface of the pigment is covered by a styrene-acryl resin, and each of the inks contains 50 mass % or more to 60 mass % or less of water with respect to the total mass of the ink. Below, description will be given in order of the yellow ink, the magenta ink, and the cyan ink which configure the ink set according to the present embodiment.

### 1.1. Yellow Ink

A yellow ink which is used for the ink set according to the present embodiment contains water and a second coloring agent. The second coloring agent is a pigment which is covered by a styrene-acryl resin. Below, detailed description will be given of components which are included in the yellow ink.

### 1.1.1. Pigment Covered by Styrene-Acryl Resin

A styrene-acryl resin is a polymer which is obtained by copolymerizing with a solution polymerization method using a styrene-based monomer, an acrylic acid-based monomer, and a polymerization initiator.

Examples of the styrene-based monomer include styrene, 2-methylstyrene, 3-methylstyrene, 4-methylstyrene, 4-ethylstyrene, α-methylstyrene, chlorostyrene, bromostyrene, divinylbenzene, trivinylbenzene, 4-methoxystyrene, 4-cyanostyrene, 1-vinylnaphthalene, 2-vinylnaphthalene, 2-vinylphenanthrene, styrene macromers, derivatives thereof, and the like.

Examples of the acrylic acid-based monomer include an acrylic acid, acrylic acid methyl, acrylic acid ethyl, acrylic acid propyl, acrylic acid butyl, acrylic acid ethylhexyl, acrylic acid octyl, acrylic acid stearyl, acrylic acid lauryl, acrylonitrile, acrylamide, methacrylic acid, methacrylic acid methyl, methacrylic acid ethyl, methacrylic acid propyl, methacrylic acid butyl, methacrylic acid ethylhexyl, methacrylic acid octyl, methacrylic acid stearyl, methacrylic acid lauryl, methacrylic acid glycidyl, methacrylonitrile, methacrylamide, itaconic acid, itaconic acid methyl, itaconic acid ethyl, fumaric acid, fumaric acid dimethyl, fumaric acid diethyl, maleic acid, maleic acid dimethyl, maleic acid diethyl, crotonic acid, crotonic acid methyl, crotonic acid ethyl, methacrylic acid methyl macromer, derivatives thereof, and the like.

In addition, during polymerization, a radical polymerization agent or a polymerization chain transfer agent which is known in the art may be added as a polymerization initiator. Examples of polymerization initiators include 2,2′-azobisisobutyronitrile, 2,2′-azobis(2,4-dimethyl valeronitrile), 2,2′-azobis(2,3-dimethyl butyronitrile), 2,2′-azobis(2-methyl butyronitrile), 2,2′-azobis(2,3,3-trimethyl butyronitrile), 2,2′-azobis(2-isopropyl butyronitrile), 1,1′-azobis(cyclohexane-1-carbonitrile), 2,2′-azobis(4-methoxy-2,4-dimethyl valeronitrile), 2-(carbamoylazo) iso butyronitrile, 4,4′-azobis(4-cyano valerianic acid), dimethyl-2,2′-azobisiso butyrate; peroxide compounds such as butyl peroxide, propyl peroxide, butyryl peroxide, benzoyl isobutyryl peroxide, and benzoyl peroxide; water-soluble polymerization initiators such as potassium peroxodisulfate, ammonium peroxodisulfate, sodium peroxodisulfate, 2,2′-azobis(2-methyl propione amidine) dihydrochloride, and 4,4′-azobis(4-cyano valeric acid), and the like. In addition, it is also possible to use a redox-based initiator where potassium peroxodisulfate, ammonium peroxodisulfate, sodium peroxodisulfate, or the like is combined with sodium sulfite, sodium hydrosulfite, ferrous sulfate, and the like. The amount of the polymerization initiator is preferably 0.001 mol to 5 mol and more preferably 0.01 mol to 2 mol per mol of a monomer mixture. During polymerization, a polymerization chain transfer agent which is known in the art such as mercaptans such as octyl mercaptan or 2-mercaptoethanol, or thiuram disulfides may be further added.

From the viewpoint that the pigment is stably dispersed, it is preferable that the weight average molecular weight (Mw) of a styrene-acryl resin is approximately 10,000 to 150,000. It is possible to measure the weight average molecular weight with a molecular weight analysis method using gel permeation chromatography (GPC).

It is possible to obtain the pigment which is covered by a styrene-acryl resin with a phase inversion emulsification method. That is, it is possible to obtain the pigment as a water dispersion body by preparing an oil-in-water type dispersion body by dissolving the styrene-acryl resin described above in an organic solvent such as methanol, ethanol, isopropanol, n-butanol, acetone, methyl ethyl ketone, and dibutyl ether, adding a pigment to the obtained solution, and then kneading after adding a neutralizer and water, performing a dispersion process, and removing the organic solvent from the obtained dispersion body. It is possible to use, for example, a ball mill, a roll mill, a bead mill, a high pressure homogenizer, a high-speed stirring-type dispersing machine, or the like for the kneading and the dispersion process.

It is preferable that the neutralizer is a tertiary amine such as ethylamine and trimethylamine, lithium hydroxide, sodium hydroxide, potassium hydroxide, ammonia, or the like and the pH of the obtained water dispersion body is preferably 6 to 10.

Examples of pigment types of the pigment which is covered by a styrene-acryl resin which is contained in the yellow ink include C.I. Pigment Yellow 1, 3, 12, 13, 14, 17, 24, 34, 35, 37, 42, 53, 55, 74, 81, 83, 95, 97, 98, 100, 101, 104, 108, 109, 110, 117, 120, 128, 138, 150, 153, 155, 174, 180, 198, and the like. Among these, it is preferable to include at least one type which is selected from a group formed of C.I. Pigment Yellow 74, 109, 110, 128, 138, 147, 150, 155, 180, and 188, and C.I. Pigment Yellow 74 is particularly preferable.

The content of the pigment which is covered by a styrene-acryl resin in the yellow ink is preferably 5 mass % or more and more preferably 5 mass % or more to 8 mass % or less with respect to the total mass of the ink. When the content of the pigment in the yellow ink is within this range, not only is the yellow coloring property favorable, but the coloring properties and color reproducibility of secondary colors are also improved in the red direction.

### 1.1.2. Water

The yellow ink contains water as the main solvent. For the water, it is preferable to use pure water or ultra-pure water such as ion-exchanged water, ultrafiltration water, reverse osmosis water, or distilled water. In particular, by using water on which a sterilizing treatment is carried out by irradiation with ultraviolet rays, adding hydrogen peroxide, or the like, it is possible to prevent the generation of mold or bacteria and store ink over a long period.

The content of the water in the yellow ink is 50 mass % or more to 60 mass % or less and preferably 55 mass % or more to 60 mass % or less with respect to the total mass of the ink. When the content of the water in the yellow ink is within this range, the coloring properties and color reproducibility of secondary colors are improved, color bleeding or curling is suppressed, and the clogging recoverability of a recording head is also favorable. When the content of the water is less than this range, since the amount of water is excessively small, the clogging recoverability of a recording head tends to be poor. On the other hand, when the content of the water exceeds this range, since the amount of water which is absorbed in cellulose in plain paper is excessively large, curling is easily generated. In addition, there is a tendency for the color gamut of the secondary colors to narrow.

### 1.1.3. Other Additive Agents

It is possible to add a water-soluble organic solvent, a surfactant, a pH adjusting agent, and the like to the yellow ink as necessary.

### Water-Soluble Organic Solvent

Examples of a water-soluble organic solvent include polyvalent alcohols such as glycerine, 1,2,6-hexanetriol, trimethylol propane, ethylene glycol, propylene glycol, diethylene glycol, triethylene glycol, tetraethylene glycol, pentaethylene glycol, dipropylene glycol, 2-butene-1,4-diol, 2-ethyl-1,3-hexadiol, 2-methyl-2,4-pentanediol, 1,2-octanediol, 1,2-hexanediol, 1,2-pentanediol, and 4-methyl-1,2-pentanediol; so-called solid wetting agents such as saccharides such as glucose, mannose, fructose, ribose, xylose, arabinose, galactose, aldonic acid, glucitol, sorbitol, maltose, cellobiose, lactose, sucrose, trehalose, and maltotriose, sugar alcohols, hyaluronic acids, and ureas; alkyl alcohols with 1 to 4 carbon atoms such as ethanol, methanol, butanol, propanol, and isopropanol; glycol ethers such as ethylene glycol monomethyl ether, ethylene glycol monoethyl ether, ethylene glycol monobutyl ether, ethylene glycol monomethyl ether acetate, diethylene glycol monomethyl ether, diethylene glycol monoethyl ether, diethylene glycol mono-n-propyl ether, ethylene glycol mono-iso-propyl ether, diethylene glycol mono-iso-propyl ether, ethylene glycol mono-n-butyl ether, ethylene glycol mono-t-butyl ether, diethylene glycol mono-n-butyl ether, diethylene glycol mono-t-butyl ether, diethylene glycol-2-ethylhexyl ether, 1-methyl-1-methoxy butanol, propylene glycol monomethyl ether, propylene glycol monoethyl ether, propylene glycol mono-n-butyl ether, propylene glycol mono-t-butyl ether, propylene glycol mono-n-propyl ether, propylene glycol mono-iso-propyl ether, dipropylene glycol monomethyl ether, dipropylene glycol monoethyl ether, dipropylene glycol mono-n-propyl ether, dipropylene glycol mono-iso-propyl ether, and triethyl glycol monobutyl ether; 2-pyrrolidone, N-methyl-2-pyrrolidone, 1,3-dimethyl-2-imidazolidinone, formamide, acetamide, dimethyl sulfoxide, sorbitan, acetin, diacetin, triacetin, sulfolane, and the like. These water-soluble organic solvents may be used as one type individually or by combining two types or more.

From the viewpoint that color bleeding or curling is effectively suppressed and that the clogging recoverability of a recording head is favorable, it is preferable that the yellow ink contains 0.5 mass % or more to 5 mass % or less of at least one type of water-soluble organic solvent, which is selected from a group formed of 1,2-alkanediol and glycol ether.

The content of the water-soluble organic solvent in the yellow ink is preferably 5 mass % or more to 50 mass % or less and more preferably 10 mass % or more to 40 mass % or less with respect to the total mass of the ink.

### Surfactant

It is possible to use any of an anionic surfactant, a cationic surfactant, an amphoteric surfactant, and a non-ionic surfactant as a surfactant; however, a non-ionic surfactant is preferable from the viewpoint of obtaining an ink where there is not much foaming or many bubbles. A non-ionic surfactant has an effect of evenly spreading an ink on a recording medium. Therefore, in a case of performing ink jet recording using an ink which includes a non-ionic surfactant, a high definition image with little bleeding is obtained.

It is preferable that the yellow ink contains a first surfactant where an HLB value is 8 or greater and a second surfactant where an HLB value is less than 8 among non-ionic surfactants. By using the first surfactant and the second surfactant in combination in this manner, since it is possible to evenly spread an ink on a recording medium, a high definition image where color bleeding is reduced is easily obtained. In addition, since it is possible to suppress the generation of bubbles, the continuous discharge stability is favorable. Here, the HLB value in the present specification is an HLB value which is defined by the Griffin method.

As the first surfactant, an alkylene oxide adduct (below, the alkylene oxide adduct is also referred to as an “AO adduct”) of acetylene glycol where the number of carbon atoms of the main chain is 12 or greater is more preferable. Here, the “main chain” in the present specification has the meaning of the main chain based on IUPAC nomenclature.

Since the acetylene glycol where the number of carbon atoms of the main chain is 12 or greater has poor hydrophilicity, there are cases where stable dissolution (dispersion) is not possible in an aqueous ink which includes water as a solvent; however, in a case of an acetylene glycol AO adduct where the number of carbon atoms of the main chain is 12 or greater, since hydrophilicity is added by the alkylene oxide, the solubility in an aqueous ink is excellent.

It is preferable that the HLB value of the AO adduct of acetylene glycol where the number of carbon atoms of the main chain is 12 or greater is 8 or more to 15 or less since the wettability described above is superior.

The AO adduct of acetylene glycol where the number of carbon atoms of the main chain is 12 or greater is not limited to the following; however, examples thereof include an ethoxylate of acetylene glycol which is represented by the following general formula (1).

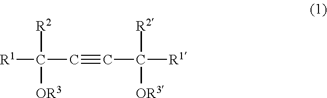

R¹, R^{1′}, R², and R^{2′} in the formula (1) described above each independently represents an alkyl group with a number of carbon atoms of 1 to 5, the number of carbon atoms of the main chain is 12 or greater, —OR³ represents —OH or —O(C₂H₄O)ₘH, and —OR^{3′} represents —OH or —O(C₂H₄O)ₙH. At this time, m and n are each independently a value which includes decimal fractions between 0.5 and 25 and m+n is a value which includes decimal fractions between 1 and 40 (here, a case where —OR³ and —OR^{3′} are both —OH is excluded).

Specific examples of the AO adduct of acetylene glycol where the number of carbon atoms of the main chain is or greater are not limited to following; however, an ethoxylate of 2,5,8,11-tetramethyl-6-dodecyne-5,8-diol and an ethoxylate of 5,8-dimethyl-6-dodecyne-5,8-diol are preferable.

The ethoxylates of the acetylene glycol described above are not limited to the following; however, examples thereof include alkylene oxide products of acetylene glycol among which an ethylene oxide product of acetylene glycol, and a propylene oxide product of acetylene glycol are preferable, and an ethylene oxide product of acetylene glycol is more preferable. It is preferable that each addition molar number in the ethylene oxide unit in the acetylene glycol is 1 to 20 mol in each of R³ and R^{3′} and it is preferable that the total number of the addition molar number (the total of R³ and R^{3′}) is 2 to 40 mol. When the total number of the addition molar number of ethylene oxide is 40 mol or less, it is possible to reduce the static and dynamic surface tension and the ink absorption performance is favorable.

Commercial products of the AO adduct of acetylene glycol where the number of carbon atoms of the main chain is or greater are not limited to the following; however, examples thereof include Olefin EXP 4300 (product name manufactured by Nissin Chemical Industry Co., Ltd., ethylene oxide adduct where the number of carbon atoms in the main chain is 12).

A first surfactant may be used as one type individually or by combining two types or more. It is preferable that the content of the first surfactant in the yellow ink is 0.5 mass % or more to 5 mass % or less with respect to the total mass of the ink.

As the second surfactant, acetylene glycol where the number of carbon atoms of the main chain is 10 or greater is more preferable. Among the acetylene glycol-based surfactants, acetylene glycol where the number of carbon atoms of the main chain is 10 or greater is able to effectively remove bubbles which are generated in an ink. Due to this, the initial filling property and continuous printing stability are superior.

The upper limit of the HLB value of the acetylene glycol where the number of carbon atoms of the main chain is 10 or greater is less than 8 since the defoaming property is excellent, preferably 7 or less, more preferably 5 or less, and even more preferably 4 or less and, on the other hand, the lower limit thereof is preferably 3 or more.

In addition, in a case where the number of carbon atoms of the main chain of acetylene glycol is 10 or greater, when an alkylene oxide is not added, the defoaming property is excellent. Since acetylene glycol where the number of carbon atoms of the main chain is 10 or greater is a component which is not easily dissolved in water, the defoaming property is excellent.

Acetylene glycol where the number of carbon atoms of the main chain is 10 or greater is not limited to the following; however, examples thereof include acetylene glycol which is represented by the following general formula (2).

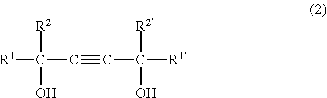

R¹, R^{1′}, R², and R^{2′} in the formula (2) described above each independently represents an alkyl group with a number of carbon atoms of 1 to 5, and the number of carbon atoms of the main chain is 10 or greater. Here, R¹, R^{1′}, R², and R^{2′} in the formula (2) are not related to R¹, R^{1′}, R², and R^{2′} in the formula (1) described above.

Specific examples of acetylene glycol where the number of carbon atoms of the main chain is 10 or greater are not limited to the following; however, 2,5,8,11-tetramethyl-6-dodecyne-5,8-diol, 5,8-dimethyl-6-dodecyne-5,8-diol, 2,4,7,9-tetramethyl-5-decyne-4,7-diol, and 4,7-dimethyl-5-decyne-4,7-diol are preferable.

Commercial products of acetylene glycol where the number of carbon atoms of the main chain is 10 or greater are not limited to the following; however, examples thereof include Surfynol 104 PG 50 (2,4,7,9-tetramethyl-5-decyne-4,7-diol) and Surfynol DF 110 D (2,5,8,11-tetramethyl-6-dodecyne-5,8-diol) (the above are product names manufactured by Air Products and Chemicals, Inc.).

The second surfactant may be used as one type individually or by combining two types or more. It is preferable that the content of the second surfactant in the yellow ink is 0.5 mass % or more to 5 mass % or less with respect to the total mass of the ink.

### PH Adjusting Agent

It is preferable to add a pH adjusting agent to the yellow ink. It is possible to use an inorganic compound such as lithium hydroxide, potassium hydroxide, and sodium hydroxide; alkanolamines such as ammonia, triethanolamine, tripropanolamine, diethanolamine, and monoethanolamine; or the like as a pH adjusting agent. In particular, it is preferable to include at least one type of pH adjusting agent which is selected from a hydroxide of an alkali metal, ammonia, triethanolamine, and tripropanolamine and to adjust the pH to 6 to 10. When the pH is not in this range, there are cases where the materials or the like which configure the ink jet printer are adversely influenced and the clogging recoverability deteriorates.

In addition, as necessary, it is possible to use collidine, imidazole, phosphoric acid, 3-(N-morpholino) propanesulfonic acid, tris(hydroxymethyl) aminomethane, boric acid, or the like as a pH buffer.

### Other Additive Agents

Furthermore, it is possible to add a defoaming agent, an antioxidant, an ultraviolet ray absorber, preservatives and fungicides, and the like to the yellow ink as necessary.

Allophanates such as allophanate and methylallophanate, biurets or the like such as biuret, dimethylbiuret, and tetramethylbiuret, L-ascorbic acid, salts thereof, or the like, Tinuvin 328, 900, 1130, 384, 292, 123, 144, 622, and 770, Irgacor 252 and 153, Irganox 1010, 1076, and 1035, MD 1024, and the like which are manufactured by Nihon Ciba-Geigy K.K., or lanthanide oxides, and the like are used as an antioxidant and an ultraviolet ray absorber.

Examples of preservatives and fungicides include sodium benzoate, pentachlorophenol sodium, 2-pyridinethiol-1-sodium oxide, sodium sorbate, sodium dehydroacetate, 1,2-dibendisochi azophosphorus-3-on (PROXEL CRL, PROXEL BDN, PROXEL GXL, PROXEL XL-2, and PROXEL TN of Nitto Denko Avecia Inc.), and the like.

### 1.2. Magenta Ink

The magenta ink which is used for an ink set according to the present embodiment contains water and a first coloring agent. Below, detailed description will be given of components which are included in the magenta ink.

### 1.2.1. First Coloring Agent

The first coloring agent is a self-dispersing pigment which has a phosphorus-containing group on the surface thereof. A self-dispersing pigment refers to a pigment which is able to be dispersed and/or dissolved in an aqueous medium without a dispersant. Here, “dispersed and/or dissolved in an aqueous medium without a dispersant” refers to a state of being stably present in an aqueous medium due to a hydrophilic group on the surface thereof even when a dispersant for dispersing a pigment is not used.

An ink which contains a self-dispersing pigment as a coloring agent may or may not contain a dispersant for dispersing a normal pigment. Therefore, foaming due to deterioration in the defoaming property caused by the dispersant hardly occurs and an ink with excellent discharge stability is easily prepared. In addition, since it is possible to suppress a large rise in viscosity caused by the dispersant, handling is easy in that it is possible to include more pigments, that it is possible to sufficiently increase the printing density, and the like.

Examples of phosphorus-containing groups include a phosphorus-containing group which has at least one P—O or P═O bond such as a phosphonic acid group, a phosphinic acid group, a phosphinous acid group, a phosphite group, a phosphate, diphosphate, triphosphate, or pyrophosphate group, and partial esters thereof or salts thereof. Such phosphorus-containing groups have a high calcium index value. The “calcium index value” refers to the scale of an ability to coordinatively bond calcium ions in a dissolved state, that is, an ability to capture calcium ions of a functional group.

In general, calcium carbonate is added to plain paper as a filler in order to add whiteness or opacity to paper or to add smoothness or flexibility to the surface of the paper. When the yellow ink is discharged onto plain paper, calcium ions which are included in the plain paper are eluted due to moisture in the yellow ink. It is considered that the coloring properties or color reproducibility of the secondary colors are favorable due to the calcium ions and a phosphorus-containing group of a first coloring agent forming a coordination bond. Furthermore, even in a case where variations in the amount of the filler depending on the paper lot are large, it is possible to obtain a stable printing quality by suppressing white spots or strike through in the secondary color image.

Here, “white spots” in the present specification refer to a phenomenon where a portion which is not inherently thin in a printed image looks thin. In addition, “strike through” refers to a state where ink is permeated to the rear surface side of the paper during printing.

The self-dispersing pigment of the magenta ink is manufactured, for example, by bonding (grafting) a phosphorus-containing group with a surface of a pigment by carrying out a physical treatment or a chemical treatment on the pigment. Examples of the physical treatment include a vacuum plasma treatment, and the like. In addition, examples of the chemical treatment include a wet oxidation method which carries out oxidation in water using an oxidizing agent, a method which bonds a carboxyl group via a phenyl group by bonding p-aminobenzoic acid with the pigment surface, and the like.

It is preferable that the first coloring agent which is included in the magenta ink is a self-dispersing pigment which has a phosphorus-containing group on the pigment surface via a phenyl group from the viewpoint of high coloring properties. It is possible to apply various types of surface treatment methods which are known in the art as a surface treatment methods for bonding a phosphorus-containing group with the pigment surface via a phenyl group and examples thereof include a method which bonds a phosphorus-containing group via a phenyl group by bonding sulfanilic acid, p-aminobenzoic acid, 4-aminosalicylic acid, and the like with the pigment surface, and the like.

Examples of a pigment which is a raw material of a self-dispersing pigment of a magenta ink include C.I. Pigment Red 1, 3, 5, 8, 9, 16, 17, 19, 22, 38, 48:3, 57:1, 90, 112, 122, 123, 127, 146, 184, 202, and 269, C.I. Pigment Violet 1, 3, 5:1, 16, 19, 23, and 38, a solid solution of C.I. Pigment Violet 19 and C.I. Pigment Red 202, and the like. Among these, it is preferable to include at least one type which is selected from a group formed of C.I. Pigment Red 48:3, 122, 202, 207, 209, and 269, C.I. Pigment Violet 19, and a solid solution of C.I. Pigment Violet 19 and C.I. Pigment Red 202.

The content of the first coloring agent in the magenta ink is preferably 9 mass % or less and more preferably 6 mass % or more to 9 mass % or less with respect to the total mass of the ink. It is preferable that the content of the first coloring agent in the magenta ink is 1 mass % or more higher than the content of the second coloring agent in the yellow ink. When the content of the first coloring agent in the magenta ink is within this range, not only are the coloring properties of the magenta ink favorable, but the coloring properties and color reproducibility of secondary colors are also improved in the red direction.

In addition, from the viewpoint of the storage stability of the ink, the prevention of nozzle clogging, and the like, it is preferable that the average particle diameter of the first coloring agent is in a range of 50 to 250 nm.

### 1.2.2. Resin Emulsion

A resin emulsion may be added to the magenta ink. A resin emulsion has an effect of improving a fixing property of an image portion of a recording object in order to fix a coloring agent to a recording medium by resin particles fusing to each other and the resin particles and the coloring component fusing to each other along with the drying of the ink.

It is preferable that the resin particles are one type or two or more types which are selected from a group formed of an acryl-based resin, a methacryl-based resin, a styrene-based resin, a urethane-based resin, an acrylamide-based resin, and an epoxy-based resin. Theses resins may be used as a homopolymer and as a copolymer as well.

Resin particles with a single particle structure may be used and resin particles which have a core and shell structure formed of a core section and a shell section which surrounds the core section may also be used. In the present specification, a “core and shell structure” has the meaning of a “form where two or more types of polymers which have different compositions are present in the particles and are separate from each other”. Accordingly, in addition to a form where the shell section completely covers the core section, the structure may also have a form where a portion of the core section is covered. In addition, the structure may have a form where a portion of a shell section polymer forms a domain or the like in the core particle. Furthermore, the resin particles may have a multi-layer structure of three or more layers which further includes one or more layers which have different compositions between the core section and the shell section.

It is possible to obtain the resin particles by emulsion polymerization which is known in the art. That is, it is possible to obtain the resin particles by emulsifying and polymerizing an unsaturated vinyl monomer in water in which a polymerization catalyst and an emulsifier are present.

Examples of unsaturated vinyl monomers include acrylic acid esters, methacrylic acid esters, aromatic vinyl compounds, vinyl esters, vinyl cyanide compounds, halogen compounds, olefins, dienes, and the like which are generally used for emulsion polymerization.

Furthermore, specific examples thereof include acrylic acid esters such as methylacrylate, ethylacrylate, isopropylacrylate, n-butylacrylate, isobutylacrylate, n-amylacrylate, isoamylacrylate, n-hexylacrylate, 2-ethylhexylacrylate, octylacrylate, decylacrylate, dodecylacrylate, octadecylacrylate, cyclohexylacrylate, phenylacrylate, benzylacrylate, and glycidylacrylate; methacrylic acid esters such as methyl methacrylate, ethyl methacrylate, isopropyl methacrylate, n-butyl methacrylate, isobutyl methacrylate, n-amyl methacrylate, isoamyl methacrylate, n-hexyl methacrylate, 2-ethylhexyl methacrylate, octyl methacrylate, decyl methacrylate, dodecyl methacrylate, octadecyl methacrylate, cyclohexyl methacrylate, phenyl methacrylate, benzyl methacrylate, and glycidyl methacrylate; vinyl ester such as vinyl acetate; vinyl cyanide compounds such as acrylonitrile and methacrylonitrile; halogen compounds such as vinylidene chloride and vinyl chloride; an aromatic vinyl compound such as styrene, α-methylstyrene, vinyltoluene, t-butylstyrene, chlorostyrene, vinyl anisole, and vinylnaphthalene; olefins such as ethylene and propylene; dienes such as butadiene and chloroprene; vinyl monomers such as vinyl ether, vinyl ketone, and vinyl pyrrolidone; unsaturated carboxylic acids such as acrylic acid, methacrylic acid, itaconic acid, fumaric acid, and maleic acid; acrylamides such as acrylamide and N,N′-dimethyl acrylamide; hydroxyl group-containing monomers such as 2-hydroxyethyl acrylate, 2-hydroxypropyl acrylate, 2-hydroxyethyl methacrylate, and 2-hydroxypropyl methacrylate.

In addition, it is possible to use resin particles which have a structure which is crosslinked by a cross-linkable monomer which has two or more polymerizable double bonds as molecules derived from the monomer described above. Examples of cross-linkable monomers which have two or more polymerizable double bonds include diacrylates such as polyethylene glycol diacrylate, triethylene glycol diacrylate, 1,3-butylene glycol diacrylate, 1,6-butylene glycol diacrylate, 1,6-hexandiol diacrylate, neopentyl glycol diacrylate, 1,9-nonane diol diacrylate, polypropylene glycol diacrylate, 2,2′-bis(4-acryloxy propyrophenyl) propane, and 2,2′-bis(4-acryloxy diethoxyphenyl) propane; triacrylates such as trimethylol propane triacrylate, trimethylol ethane triacrylate, and tetramethylol methane triacrylate; tetraacrylates such as ditrimethylol tetraacrylate, tetramethylol metane tetraacrylate, and pentaerythritol tetraacrylate; hexaacrylates such as dipentaerythritol hexaacrylate; dimethacrylates such as ethylene glycol dimethacrylate, diethylene glycol dimethacrylate, triethylene glycol dimethacrylate, polyethylene glycol dimethacrylate, 1,3-butylene glycol dimethacrylate, 1,4-butylene glycol dimethacrylate, 1,6-hexandiol dimethacrylate, neopentyl glycol dimethacrylate, dipropylene glycol dimethacrylate, polypropylene glycol dimethacrylate, polybutylene glycol dimethacrylate, and 2,2′-bis(4-methacryloxy diethoxyphenyl) propane; trimethacrylates such as trimethylol propane methacrylate and trimethylol ethane tri methacrylate; methylene bisacrylamide, and divinylbenzene and it is possible to use these independently or in a mixture of two or more types.

In addition, it is possible to use a polymerization initiator, an emulsifier, and a molecular weight regulator which are used during the emulsion polymerization according to normal methods.

The same polymerization initiator as the polymerization initiator which is used for normal radical polymerization is used as the polymerization initiator and examples thereof include potassium peroxodisulfate, ammonium peroxodisulfate, hydrogen peroxide, azobisisobutyronitrile, benzoyl peroxide, dibutyl peroxide, peracetic acid, cumene hydroperoxide, t-butyl hydroperoxide, paramenthane hydroperoxide, and the like. In particular, in a case of performing the polymerization reaction in water, a water-soluble polymerization initiator is preferable.

Examples of emulsifiers include emulsifiers which are generally used as an anionic surfactant, a non-ionic surfactant, or an amphoteric surfactant in addition to sodium lauryl sulfate, and a mixture of these and it is possible to use these individually or in a mixture of two or more types.

In a case of manufacturing the resin particles by emulsion polymerization, particularly in a case of manufacturing a polymer emulsion which is configured from anionic resin particles by emulsion polymerization, since negative polar groups such as a carboxyl group or a sulfonic acid group are present on the surfaces of the resin particles, the pH is inclined to be acidic and a rise in viscosity or aggregation easily occurs. Thus, in general, neutralizing is performed using a basic substance. It is possible to use ammonia, organic amines, inorganic hydroxides, and the like as the basic substance. From the viewpoint of the long-term storage stability and the discharge stability of polymer emulsion and the magenta ink, among these, a monovalent inorganic hydroxide (potassium hydroxide, sodium hydroxide, or lithium hydroxide) is particularly preferable. The addition amount of the neutralizer described above is appropriately determined such that the pH of the polymer emulsion is in a range of 7.5 to 9.5, preferably in a range of 7.5 to 8.5.

From the viewpoint of the long-term storage stability and the discharge stability of the magenta ink, a preferable particle diameter of the resin particles is in a range of 5 to 400 nm and more preferably in a range of 50 to 200 nm.

In addition, the addition amount of these resin emulsions may be appropriately determined in consideration of the fixing property and the like; however, it is preferable to include 2 mass % or more of the solid content in the magenta ink.

### 1.2.3. Other Additive Agents

The magenta ink contains the same surfactant as the surfactant in the case of the yellow ink described above and additionally, contains 50 mass % or more to 60 mass % or less and preferably 55 mass % or more to 60 mass % or less of water with respect to the total mass of the ink. Furthermore, it is possible to add a water-soluble organic solvent, a pH adjusting agent, a pH buffer, a defoaming agent, an antioxidant, an ultraviolet ray absorber, preservatives and fungicides, and the like to the magenta ink as necessary in the same manner as the case of the yellow ink. These specific examples, addition amounts, and operational effects due to the addition are the same as in the case of the yellow ink described above.

### 1.3. Cyan Ink

The cyan ink which is used for an ink set according to the present embodiment contains water and the first coloring agent. Below, detailed description will be given of components which are included in the cyan ink.

The first coloring agent is the same as that of the magenta ink described above and is a self-dispersing pigment which has a phosphorus-containing group on the surface thereof. The phosphorus-containing group which is bonded with the self-dispersing pigment and the bonding mechanism thereof is the same as for the magenta ink described above.

Examples of the pigment which is the raw material of the self-dispersing pigment of the cyan ink include C.I. Pigment Blue 1, 2, 15, 15:1, 15:2, 15:3, 15:4, and 16. Among these, it is preferable to include at least one type which is selected from a group formed of C.I. Pigment Blue 15:3 and 15:4.

The content of the first coloring agent in the cyan ink is preferably 5 mass % or more and more preferably 5 mass % or more to 8 mass % or less with respect to the total mass of the ink. When the content of the first coloring agent in the cyan ink is within this range, not only are the coloring properties of the cyan ink favorable, but the coloring properties and color reproducibility of secondary colors are also improved.

In addition, from the viewpoint of the storage stability of the ink, the prevention of nozzle clogging, and the like, it is preferable that the average particle diameter of the first coloring agent is in a range of 50 to 250 nm.

In addition, the cyan ink contains the same surfactant as the surfactant in the case of the yellow ink or the magenta ink described above and additionally contains 50 mass % or more to 60 mass % or less and preferably 55 mass % or more to 60 mass % or less of water with respect to the total mass of the ink. Furthermore, it is possible to add a water-soluble organic solvent, a surfactant, a resin emulsion, a pH adjusting agent, a pH buffer, a defoaming agent, an antioxidant, an ultraviolet ray absorber, preservatives and fungicides, and the like to the cyan ink as necessary in the same manner as the case of the yellow ink or the magenta ink. These specific examples, addition amounts, and operational effects due to the addition are the same as in the case of the yellow ink or the magenta ink described above.

### 1.4. Features of Ink Set

An ink set according to the present embodiment is provided with the yellow ink, the magenta ink, and the cyan ink described above. According to the ink set, in a case of discharging the yellow ink onto a recording medium, moisture which is included in the yellow ink elutes polyvalent metal ions which are included in the recording medium. It is considered that when discharging the magenta ink and/or the cyan ink, since the polyvalent metal ion and a phosphorus-containing group on a self-dispersing pigment surface of the magenta ink and/or the cyan ink enter a state of easily reacting with each other, the coloring properties and color reproducibility of secondary colors are improved. In addition, by the ink set having the configuration described above, color bleeding or curling is suppressed and the clogging recoverability of a recording head is also favorable.

The ink set according to the present embodiment may be additionally provided with other inks (for example, a black ink, a light cyan ink, a light magenta ink, a white ink, and the like) as long as the yellow ink, the magenta ink, and the cyan ink described above are provided.

In the ink set according to the present embodiment, it is preferable that the content of the pigment of the coloring agent of each ink satisfies a relationship of 9 mass %≧magenta ink>yellow ink≧cyan ink≧5 mass %. Furthermore, it is preferable that the content of the coloring agent of the magenta ink is 1 mass % or more higher than the content of the coloring agent of the yellow ink. By having such a relationship, the coloring properties and color reproducibility of secondary colors are improved, particularly in the red direction. Furthermore, even in a case where variations in the amount of the filler depending on the paper lot are large, it is possible to obtain a stable printing quality by suppressing white spots or a strike through in the secondary color image.

### 2. Liquid Ejecting Head

A liquid ejecting head according to the present embodiment is provided with a nozzle row for ejecting each of the inks in the ink set described above, in which a nozzle row for ejecting a yellow ink is arranged on an upstream side of nozzle rows for ejecting a magenta ink and a cyan ink. Here, “a nozzle row is arranged on an upstream side” refers to a nozzle row of a target ink being arranged such that the target ink is ejected earlier than a reference ink in one scan of the liquid ejecting head.

By the nozzle row for ejecting the yellow ink being arranged on the upstream side, in a case of forming secondary colors, the magenta ink and/or the cyan ink are ejected onto the recording medium after the yellow ink is ejected onto the recording medium. By doing so, since moisture which is included in the yellow ink elutes polyvalent metal ions which are included in a recording medium, the polyvalent metal ions in the recording medium and the phosphorus-containing group on the self-dispersing pigment surface of the magenta ink and/or a cyan ink enter a state of easily reacting with each other, thus the coloring properties and color reproducibility of secondary colors are improved.

The liquid ejecting head according to the present embodiment may be a serial type liquid ejecting head which scans in a direction which is orthogonal with respect to a paper transport direction (a main scanning direction) or may be a line type liquid ejecting head where nozzle rows are arrayed in a direction which is orthogonal with respect to the paper transport direction (the main scanning direction). In either type, the nozzle row for ejecting the yellow ink is arranged on an upstream side.

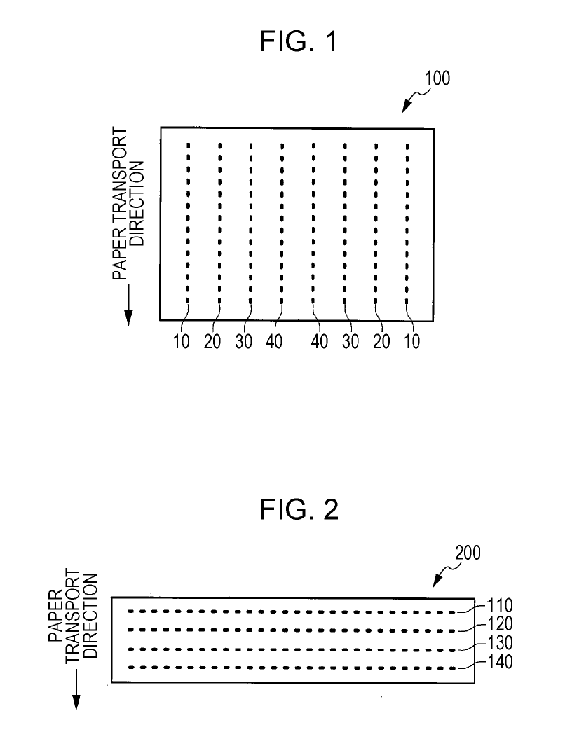

FIG. 1 is an explanatory diagram where a liquid ejecting head (serial type) according to the present embodiment is viewed from a nozzle surface. As shown in FIG. 1, a liquid ejecting head 100 is a serial type and nozzle rows of each color are provided along the main scanning direction to form a nozzle array which is symmetric to the left and right with regard to a yellow 10, a magenta 20, and a cyan 30 (and a black 40) from the outside. By arranging the nozzle rows in this manner, in a case of forming secondary colors, the effects described above are easily obtained since the magenta ink and/or the cyan ink are ejected onto a recording medium after the yellow ink is ejected onto the recording medium.

FIG. 2 is an explanatory diagram where a liquid ejecting head (line type) according to the present embodiment is viewed from a nozzle surface. As shown in FIG. 2, a liquid ejecting head 200 is a line type and a nozzle row of each color are provided in a direction which is orthogonal with the main scanning direction and form a nozzle array which is yellow 110, magenta 120, and cyan 130 (and black 140) from an upstream side. In addition, the liquid ejecting head 200 has a recording region with the width of the transported recording medium or more and is able to record an image of one line in a batch with respect to the transported recording medium. By arranging the nozzle rows in this manner, in a case of forming secondary colors, the effects described above are easily obtained since the magenta ink and/or the cyan ink are ejected onto a recording medium after the yellow ink is ejected onto the recording medium.

### 3. Examples

Below, more detailed description will be given of embodiments of the invention using examples and comparative examples; however, the invention is not limited in any way by these examples.

### 3.1. Preparing Pigment Dispersion

### 3.1.1. Surface Treatment 1

500 g of a pigment, 1 L of ion-exchanged water, and 4-aminophenyl-2-sulfatoethyl sulfone (APSES) which are described in Table 2 were added to a Processall 4HV mixer (4 liter). Subsequently, the generated mixture was heated to 60° C. while being strongly mixed at 300 rpm for 10 minutes. A 20% sodium nitride solution (1 equivalent when the amount of APSES was set as a reference) was added thereto for 15 minutes. Heating and mixing were continued for 3 hours in total.

The contents in the mixer were extracted by being diluted with 750 mL of ion-exchanged water and subsequently a dispersion generated by diafiltration using ion-exchanged water was purified. At the end of the diafiltration (the conductivity of the permeated liquid<200 microsiemens), the concentration of the pigment was adjusted to 15% and centrifuging was carried out by a Ka continuation centrifuge machine (a pilot huge).

Subsequently, 9.39 g of alendronate sodium (monosodium salt of (4-amino-1-hydroxybutane-1,1-diil) bisphosphonic acid) was added to a 2.5 L beaker. 37.56 g of ion-exchanged water was added thereto and subsequently 64.73 g of a 10% sodium hydroxide aqueous solution was added. The mixture was stirred until the solid body is dissolved. 500 g of a dispersion (20% solid content) was introduced by transporting by pumping at approximately 25 mL/min while being heavily stirred. After all of the dispersion was added, it was confirmed that the pH exceeded 12.5 by measuring the pH. Mixing was continued at 70° C. for 4 hours.

The dispersion which was obtained in this manner was diluted to 5% and then diafiltration was carried out with ion-exchanged water until the pH of the permeated liquid became less than 8 (after a first diafiltration part by volume, a holding liquid was thickened to 10% solid content). Subsequently, the dispersion (which was adjusted to a solid content concentration of approximately 13%) was ultrasonically treated using a Misonix probe sound wave processor, then large particles were removed by centrifuging at 5000 G for 10 minutes using a Beckman ultracentrifuge, and a pigment dispersion described in Table 2 was obtained. Here, in Table 2, a surface treatment method of the pigment which is obtained in this manner is described as “surface treatment 1”.

### 3.1.2. Surface Treatment 2

Using 20 parts by mass of an organic solvent (methylethyl ketone), 0.03 parts by mass of a polymerization chain transfer agent (2-mercaptoethanol), a polymerization initiator, and each monomer shown in Table 1, polymerization was carried out while stirring at 75° C. after being added to a reaction container in which nitrogen gas substitution was sufficiently performed, 0.9 parts by mass of 2,2′-azobis(2,4-dimethyl valeronitrile) which was dissolved in 40 parts by mass of methylethyl ketone was added with respect to 100 parts by mass of a monomer component, aging was carried out at 80° C. for 1 hour, and a polymer solution was obtained.

TABLE 1

| Composition of Monomer Mixture | Parts by mass |
|---|---|
| Polypropylene glycol monomethacrylate (PO = 9) | 15 |
| Poly (ethylene glycol, propylene glycol) monomethacrylate | 15 |
| (EO = 5, PO = 7) | |
| Methacrylic acid | 12 |
| Styrene monomer | 40 |
| Styrene macromere | 15 |
| Benzyl methacrylate | 10 |

EO Ethylene oxide
PO Propylene oxide

Subsequently, 7.5 parts by mass of the polymer solution which was obtained described above was dissolved in 45 parts by mass of methylethyl ketone as solid content, a salt-forming group was neutralized by adding a predetermined amount of a 20% sodium hydroxide aqueous solution (a neutralizer) thereto, and mixing and kneading were further carried out in a bead mill for 2 hours by adding 20 parts by mass of the pigment described in Table 2. After stirring by adding 120 parts by mass of ion-exchanged water to the kneaded mixture which was obtained in this manner, each of the pigment dispersions described in Table 2 was obtained by removing methylethyl ketone at 60° C. under reduced pressure and further removing a portion of the water. Here, in Table 2, the surface treatment method of the pigment which was obtained in this manner is described as “surface treatment 2”.

Table 2 below shows the pigment type of each ink in the ink set which was used in the examples and the comparative examples and the surface treatment method of the pigment.

TABLE 2

| | Yellow Ink | | Magenta Ink | | Cyan Ink | |
|---|---|---|---|---|---|---|
| | | Surface | | Surface | | Surface |
| | Pigment | Treatment | | Treatment | Pigment | Treatment |
| | Type | Method | PigmentType | Method | Type | Method |
| Example 1 | PY74 | Surface Treatment 2 | PV19 + PR202 | Surface Treatment 1 | PB15:3 | Surface Treatment 1 |
| Example 2 | PY74 | Surface Treatment 2 | PV19 + PR202 | Surface Treatment 1 | PB15:4 | Surface Treatment 1 |
| Example 3 | PY74 | Surface Treatment 2 | PV19 | Surface Treatment 1 | PB15:3 | Surface Treatment 1 |
| Example 4 | PY74 | Surface Treatment 2 | PR202 | Surface Treatment 1 | PB15:3 | Surface Treatment 1 |
| Example 5 | PY74 | Surface Treatment 2 | PR269 | Surface Treatment 1 | PB15:3 | Surface Treatment 1 |
| Example 6 | PY74 | Surface Treatment 2 | PR48:3 | Surface Treatment 1 | PB15:3 | Surface Treatment 1 |
| Example 7 | PY74 | Surface Treatment 2 | PV19 + PR202 | Surface Treatment 1 | PB15:3 | Surface Treatment 1 |
| Comparative | PY74 | Surface Treatment 1 | PV19 + PR202 | Surface Treatment 1 | PB15:3 | Surface Treatment 1 |
| Example 1 | | | | | | |
| Comparative | PY74 | Surface Treatment 2 | PV19 + PR202 | Surface Treatment 2 | PB15:3 | Surface Treatment 2 |
| Example 2 | | | | | | |
| Comparative | PY74 | Surface Treatment 2 | PV19 + PR202 | Surface Treatment 2 | PB15:3 | Surface Treatment 1 |
| Example 3 | | | | | | |
| Comparative | PY74 | Surface Treatment 1 | PV19 + PR202 | Surface Treatment 2 | PB15:3 | Surface Treatment 2 |
| Example 4 | | | | | | |
| Comparative | PY74 | Surface Treatment 2 | PV19 + PR202 | Surface Treatment 1 | PB15:3 | Surface Treatment 1 |
| Example 5 | | | | | | |
| Comparative | PY74 | Surface Treatment 2 | PV19 + PR202 | Surface Treatment 1 | PB15:3 | Surface Treatment 1 |
| Example 6 | | | | | | |

### 3.2. Preparing Resin Emulsion

900 g of ion-exchanged water and 1 g of sodium lauryl sulfate were prepared in a reaction container provided with a stirrer, a reflux condenser, a dripping apparatus, and a thermometer and the temperature was increased to 70° C. while substituting nitrogen while stirring. After keeping the inner temperature at 70° C., adding 4 g of potassium peroxodisulfate as a polymerization initiator, and carrying out dissolving, an emulsion which was produced by adding 20 g of acrylamide, 365 g of styrene, 545 g of butylacrylate, and 30 g of methacryl acid to 450 g of ion-exchanged water and 3 g of sodium lauryl sulfate in advance while stirring was continuously dripped into the reaction solution over 4 hours. After the dripping finished, aging was performed for 3 hours. After cooling the obtained resin emulsion to room temperature, the obtained resin emulsion was adjusted to a solid content of 25 parts by mass and a pH of 8 by adding ion-exchanged water and a sodium hydroxide aqueous solution. The glass transition temperature of the resin particles in the obtained emulsion was −6° C.

### 3.3. Preparing Each Ink

Subsequently, a water-soluble organic solvent, a surfactant, a pH adjusting agent, a resin emulsion, and ion-exchanged water were added to the pigment dispersion which was obtained as described above so as to obtain the compositions described in Table 3 and Table 4. After that, an ink set was set by preparing each of the inks by mixing and stirring at room temperature for 1 hour and carrying out further filtering with a membrane filter with a hole diameter of 5 μm. Here, numeric values in the Tables represent content (mass reference %) in the ink.

### 3.4. Evaluation Method

### 1. Evaluation of Coloring Property of Plain Paper (Gamut Volume)

With regard to each of the prepared ink sets, a dedicated output pattern formed of 400 patches was printed using an ink jet printer PX-A650 (manufactured by Seiko Epson Corp.). The head of the ink jet printer PX-A650 is a serial type and nozzle rows of each color are provided along the main scanning direction and is a nozzle array which is symmetric to the left and right with regard to yellow, magenta, and cyan from the outside. Color measuring was performed for all of the patches of a printed object and the volume in the 3D space of L*a*b* was calculated by a calculation tool. The calculated Gamut Volume is dimensionless. The evaluation of the coloring properties was determined based on criteria which will be described below using the value of the calculated Gamut Volume. In addition, with regard to color measuring data of L*a*b*, plotting was carried out so as to project in a two-dimensional space of a*b*. From the plotted group, a value of C* (color saturation) which becomes the maximum at a hue angle of 6.7 degrees in the (Red) direction was obtained. These results are shown together in Table 3 and Table 4.

A: 240000 or more
B: 200000 or more to less than 240000
C: less than 200000

### 2. Evaluation of Coloring Property of Plain Paper (White Spots)

Printing of a 100% Duty patch pattern of green patches was performed using Xerox 4200 as recording paper with the same method as in the evaluation of the Gamut Volume described above. With regard to the obtained printed object, visual evaluation was carried out based on the criteria which will be described below. The results are shown together in Table 3 and Table 4.

A: There are no white spots or almost none.
B: There are white spots; however, the white spots are not remarkable.
C: White spots are remarkable.

### 3. Evaluation of Bleeding

A pattern of 11 point gothic type characters of each of magenta and cyan was printed on a background yellow 100% solid pattern using Xerox 4200 as recording paper with the same method as the evaluation of the Gamut Volume described above. Bleeding to the background in such a case was visually evaluated based on the criteria which will be described below. The results are shown together in Table 3 and Table 4.

A: There is no bleeding.
B: There is bleeding, but the bleeding is not remarkable.
C: The bleeding is remarkable.

### 4. Curling Evaluation

A 100% solid pattern was printed on XeroxP paper (A4 size) as recording paper with regard to each of yellow, magenta, and cyan with the same method as in the evaluation of the Gamut Volume described above. After being left flat inside a room for one week, the average value of lifting-up amounts at the four corners was determined. The results are shown together in Table 3 and Table 4.

A: 20 mm or less for all the colors
B: 20 mm or more for any of the colors

### 5. Clogging Recoverability

After confirming that each ink is discharged from all the nozzles using an ink jet printer PX-A650 (manufactured by Seiko Epson Corp.), the ink jet printer was left in a state where there were no ink cartridges at a position other than a home position (a state where a head was shifted from the position of a cap provided in the printer and the head was not capped) in an environment of 40° C. for one week. After being left, inks were discharged from all the nozzles again, the frequency of cleaning necessary until printing which was equivalent to the initial printing became possible was measured, and the results were evaluated based on the criteria below. The results are shown together in Table 3 and Table 4.

A: A case where printing which is equivalent to the initial printing is obtained by cleaning three times or less
B: A case where printing which is equivalent to the initial printing is obtained by cleaning four times or more to nine times or less

C: A case where printing which is equivalent to the initial printing is not possible even by cleaning ten times or more

### 3.5. Evaluation Results

The compositions of each of the inks which were used in each of the ink sets of the examples and the comparative examples and the results of the evaluation tests are shown in Table 3 and Table 4.

TABLE 3

| | | Example 1 | | | Example 2 | | | Example 3 | | | Example 4 | | |
|---|---|---|---|---|---|---|---|---|---|---|---|---|---|
| | | Yellow | Magenta | Cyan | Yellow | Magenta | Cyan | Yellow | Magenta | Cyan | Yellow | Magenta | Cyan |
| Yellow pigment dispersion | | 6.0 | — | — | 6.0 | — | — | 6.0 | — | — | 6.0 | — | — |
| (solid content) | | | | | | | | | | | | | |
| Magenta pigment dispersion | | — | 8.5 | — | — | 8.5 | — | — | 8.5 | — | — | 8.5 | — |
| (solid content) | | | | | | | | | | | | | |
| Cyan pigment dispersion | | — | — | 5.5 | — | — | 5.5 | — | — | 5.5 | — | — | 5.5 |
| (solid content) | | | | | | | | | | | | | |
| Styrene acryl resin emulsion | | — | 2.0 | 2.0 | — | 2.0 | 2.0 | — | 2.0 | 2.0 | — | 2.0 | 2.0 |
| (solid content) | | | | | | | | | | | | | |
| Water- | Glycerine | 10.0 | 10.0 | 10.0 | 10.0 | 10.0 | 10.0 | 10.0 | 10.0 | 10.0 | 10.0 | 10.0 | 10.0 |
| soluble | Trimethylol | 4.0 | 4.0 | 4.0 | 4.0 | 4.0 | 4.0 | 4.0 | 4.0 | 4.0 | 4.0 | 4.0 | 4.0 |
| organic | propane | | | | | | | | | | | | |
| solvent | Triethylene | 11.0 | 6.5 | 9.5 | 11.0 | 6.5 | 9.5 | 11.0 | 6.5 | 9.5 | 11.0 | 6.5 | 9.5 |
| | glycol | | | | | | | | | | | | |
| | 2-pyrrolidone | 4.0 | 4.0 | 4.0 | 4.0 | 4.0 | 4.0 | 4.0 | 4.0 | 4.0 | 4.0 | 4.0 | 4.0 |
| | 1,2-hexane diol | 3.0 | 3.0 | 3.0 | 3.0 | 3.0 | 3.0 | 3.0 | 3.0 | 3.0 | 3.0 | 3.0 | 3.0 |
| | Triethylene | 2.0 | 2.0 | 2.0 | 2.0 | 2.0 | 2.0 | 2.0 | 2.0 | 2.0 | 2.0 | 2.0 | 2.0 |
| | glycol mono | | | | | | | | | | | | |
| | butyl ether | | | | | | | | | | | | |
| Surfactant | Olefin EXP4300 | 0.5 | 0.5 | 0.5 | 0.5 | 0.5 | 0.5 | 0.5 | 0.5 | 0.5 | 0.5 | 0.5 | 0.5 |
| | Surfynol | 0.5 | 0.5 | 0.5 | 0.5 | 0.5 | 0.5 | 0.5 | 0.5 | 0.5 | 0.5 | 0.5 | 0.5 |
| | 104PG50 | | | | | | | | | | | | |
| pH adjuster | Triethanolamine | 1.0 | 1.0 | 1.0 | 1.0 | 1.0 | 1.0 | 1.0 | 1.0 | 1.0 | 1.0 | 1.0 | 1.0 |

| | | | | | | | | | | | | |
|---|---|---|---|---|---|---|---|---|---|---|---|---|
| Ion exchanged water | 58.0 | 58.0 | 58.0 | 58.0 | 58.0 | 58.0 | 58.0 | 58.0 | 58.0 | 58.0 | 58.0 | 58.0 |

| | | | | | |
|---|---|---|---|---|---|
| Color | Gamut volume | A | A | A | A |
| properties | C* (6.7 degrees) | 63.5 | 63.0 | 61.8 | 61.0 |
| Evaluation | Plain paper | A | A | A | A |

| Bleeding | A | A | | | A | | | A | | |
|---|---|---|---|---|---|---|---|---|---|---|
| Curling | A | A | | | A | | | A | | |
| Clogging recoverability | A | A | | | A | | | A | | |
| | | Example 5 | | | Example 6 | | | Example 7 | | |
| | | Yellow | Magenta | Cyan | Yellow | Magenta | Cyan | Yellow | Magenta | Cyan |

| Yellow pigment dispersion | | 6.0 | — | — | 6.0 | — | — | 6.0 | — | — |
|---|---|---|---|---|---|---|---|---|---|---|
| (solid content) | | | | | | | | | | |
| Magenta pigment dispersion | | — | 8.5 | — | — | 8.5 | — | — | 8.5 | — |
| (solid content) | | | | | | | | | | |
| Cyan pigment dispersion | | — | — | 5.5 | — | — | 5.5 | — | — | 5.5 |
| (solid content) | | | | | | | | | | |
| Styrene acryl resin emulsion | | — | 2.0 | 2.0 | — | 2.0 | 2.0 | — | 2.0 | 2.0 |
| (solid content) | | | | | | | | | | |
| Water- | Glycerine | 10.0 | 10.0 | 10.0 | 10.0 | 10.0 | 10.0 | 10.0 | 10.0 | 10.0 |
| soluble | Trimethylol | 4.0 | 4.0 | 4.0 | 4.0 | 4.0 | 4.0 | 4.0 | 4.0 | 4.0 |
| organic | propane | | | | | | | | | |
| solvent | Triethylene | 11.0 | 6.5 | 9.5 | 11.0 | 6.5 | 9.5 | 16.0 | 11.5 | 14.5 |
| | glycol | | | | | | | | | |
| | 2-pyrrolidone | 4.0 | 4.0 | 4.0 | 4.0 | 4.0 | 4.0 | 4.0 | 4.0 | 4.0 |
| | 1,2-hexane diol | 3.0 | 3.0 | 3.0 | 3.0 | 3.0 | 3.0 | 3.0 | 3.0 | 3.0 |
| | Triethylene | 2.0 | 2.0 | 2.0 | 2.0 | 2.0 | 2.0 | 2.0 | 2.0 | 2.0 |
| | glycol mono | | | | | | | | | |
| | butyl ether | | | | | | | | | |
| Surfactant | Olefin EXP4300 | 0.5 | 0.5 | 0.5 | 0.5 | 0.5 | 0.5 | 0.5 | 0.5 | 0.5 |
| | Surfynol | 0.5 | 0.5 | 0.5 | 0.5 | 0.5 | 0.5 | 0.5 | 0.5 | 0.5 |
| | 104PG50 | | | | | | | | | |
| pH adjuster | Triethanolamine | 1.0 | 1.0 | 1.0 | 1.0 | 1.0 | 1.0 | 1.0 | 1.0 | 1.0 |

| | | | | | | | | | |
|---|---|---|---|---|---|---|---|---|---|
| Ion exchanged water | 58.0 | 58.0 | 58.0 | 58.0 | 58.0 | 58.0 | 53.0 | 53.0 | 53.0 |

| | | | | |
|---|---|---|---|---|
| Color | Gamut volume | A | A | A |
| properties | C* (6.7 degrees) | 60.3 | 60.0 | 60.0 |
| Evaluation | Plain paper | A | A | A |

| | | | |
|---|---|---|---|
| Bleeding | A | A | A |
| Curling | A | A | A |
| Clogging recoverability | A | A | B |

TABLE 4

| | | Comparative | | | Comparative | | | Comparative | | | Comparative | | |
|---|---|---|---|---|---|---|---|---|---|---|---|---|---|
| | | Example 1 | | | Example 2 | | | Example 3 | | | Example 4 | | |
| | | Yellow | Magenta | Cyan | Yellow | Magenta | Cyan | Yellow | Magenta | Cyan | Yellow | Magenta | Cyan |
| Yellow pigment dispersion | | 6.0 | — | — | 6.0 | — | — | 6.0 | — | — | 6.0 | — | — |
| (solid content) | | | | | | | | | | | | | |
| Magenta pigment dispersion | | — | 8.5 | — | — | 8.5 | — | — | 8.5 | — | — | 8.5 | — |
| (solid content) | | | | | | | | | | | | | |
| Cyan pigment dispersion | | — | — | 5.5 | — | — | 5.5 | — | — | 5.5 | — | — | 5.5 |
| (solid content) | | | | | | | | | | | | | |
| Styrene acryl resin emulsion | | 2.0 | 2.0 | 2.0 | — | — | — | — | — | 2.0 | 2.0 | — | — |
| (solid content) | | | | | | | | | | | | | |
| Water- | Glycerine | 10.0 | 10.0 | 10.0 | 10.0 | 10.0 | 10.0 | 10.0 | 10.0 | 10.0 | 10.0 | 10.0 | 10.0 |
| soluble | Trimethylol | 4.0 | 4.0 | 4.0 | 4.0 | 4.0 | 4.0 | 4.0 | 4.0 | 4.0 | 4.0 | 4.0 | 4.0 |
| organic | propane | | | | | | | | | | | | |
| solvent | Triethylene | 9.0 | 6.5 | 9.5 | 11.0 | 8.5 | 11.5 | 11.0 | 8.5 | 9.5 | 9.0 | 8.5 | 11.5 |
| | glycol | | | | | | | | | | | | |
| | 2-pyrrolidone | 4.0 | 4.0 | 4.0 | 4.0 | 4.0 | 4.0 | 4.0 | 4.0 | 4.0 | 4.0 | 4.0 | 4.0 |
| | 1,2-hexane diol | 3.0 | 3.0 | 3.0 | 3.0 | 3.0 | 3.0 | 3.0 | 3.0 | 3.0 | 3.0 | 3.0 | 3.0 |
| | Triethylene | 2.0 | 2.0 | 2.0 | 2.0 | 2.0 | 2.0 | 2.0 | 2.0 | 2.0 | 2.0 | 2.0 | 2.0 |
| | glycol mono | | | | | | | | | | | | |
| | butyl ether | | | | | | | | | | | | |
| Surfactant | Olefin EXP4300 | 0.5 | 0.5 | 0.5 | 0.5 | 0.5 | 0.5 | 0.5 | 0.5 | 0.5 | 0.5 | 0.5 | 0.5 |
| | Surfynol | 0.5 | 0.5 | 0.5 | 0.5 | 0.5 | 0.5 | 0.5 | 0.5 | 0.5 | 0.5 | 0.5 | 0.5 |
| | 104PG50 | | | | | | | | | | | | |
| pH adjuster | Triethanolamine | 1.0 | 1.0 | 1.0 | 1.0 | 1.0 | 1.0 | 1.0 | 1.0 | 1.0 | 1.0 | 1.0 | 1.0 |

| | | | | | | | | | | | | |
|---|---|---|---|---|---|---|---|---|---|---|---|---|
| Ion exchanged water | 58.0 | 58.0 | 58.0 | 58.0 | 58.0 | 58.0 | 58.0 | 58.0 | 58.0 | 58.0 | 58.0 | 58.0 |

| | | | | | |
|---|---|---|---|---|---|
| Color | Gamut volume | B | C | B | B |
| properties | C* (6.7 degrees) | 58.8 | 55.0 | 57.5 | 57.9 |
| Evaluation | Plain paper | B | C | B | C |

| Bleeding | B | B | B | | | C | | |
|---|---|---|---|---|---|---|---|---|
| Curling | A | A | A | | | A | | |
| Clogging recoverability | A | A | A | | | A | | |
| | | | Comparative | | | Comparative | | |
| | | | Example 5 | | | Example 6 | | |
| | | | Yellow | Magenta | Cyan | Yellow | Magenta | Cyan |

| Yellow pigment dispersion | | 6.0 | — | — | 6.0 | — | — |
|---|---|---|---|---|---|---|---|
| (solid content) | | | | | | | |
| Magenta pigment dispersion | | — | 8.5 | — | — | 8.5 | — |
| (solid content) | | | | | | | |
| Cyan pigment dispersion | | — | — | 5.5 | — | — | 5.5 |
| (solid content) | | | | | | | |
| Styrene acryl resin emulsion | | — | 2.0 | 2.0 | — | 2.0 | 2.0 |
| (solid content) | | | | | | | |
| Water- | Glycerine | 10.0 | 10.0 | 10.0 | 10.0 | 10.0 | 10.0 |
| soluble | Trimethylol | 4.0 | 4.0 | 4.0 | 4.0 | 4.0 | 4.0 |
| organic | propane | | | | | | |
| solvent | Triethylene | 6.0 | 1.5 | 4.5 | 21.0 | 16.5 | 19.5 |
| | glycol | | | | | | |
| | 2-pyrrolidone | 4.0 | 4.0 | 4.0 | 4.0 | 4.0 | 4.0 |
| | 1,2-hexane diol | 3.0 | 3.0 | 3.0 | 3.0 | 3.0 | 3.0 |
| | Triethylene | 2.0 | 2.0 | 2.0 | 2.0 | 2.0 | 2.0 |
| | glycol mono | | | | | | |
| | butyl ether | | | | | | |
| Surfactant | Olefin EXP4300 | 0.5 | 0.5 | 0.5 | 0.5 | 0.5 | 0.5 |
| | Surfynol | 0.5 | 0.5 | 0.5 | 0.5 | 0.5 | 0.5 |
| | 104PG50 | | | | | | |
| pH adjuster | Triethanolamine | 1.0 | 1.0 | 1.0 | 1.0 | 1.0 | 1.0 |

| | | | | | | |
|---|---|---|---|---|---|---|
| Ion exchanged water | 63.0 | 63.0 | 63.0 | 48.0 | 48.0 | 48.0 |

| | | | |
|---|---|---|---|
| Color | Gamut volume | B | A |
| properties | C* (6.7 degrees) | 59.1 | 62.6 |
| Evaluation | Plain paper | A | A |

| | | |
|---|---|---|
| Bleeding | A | A |
| Curling | B | A |
| Clogging recoverability | A | C |

Here, the product names in Table 3 and Table 4 are as follows.

Olefin EXP 4300 (manufactured by Nissin Chemical Co., Ltd., an ethylene oxide adduct where the number of carbon atoms in the main chain is 12)

Surfynol 104 PG 50 (manufactured by Air Products and Chemicals, Inc., 2,4,7,9-tetramethyl-5-decyne-4,7-diol)

From the results of Table 3 and Table 4, it is understood that, according to the ink sets of Examples 1 to 7, the coloring properties or color reproducibility of secondary colors was superior to the ink sets of Comparative Examples 1 to 4. Here, in the evaluation of the gamut volume, the difference in the periphery of a hue angle of 6.7 degrees (red direction) was particularly remarkable.

On the other hand, with regard to the ink set of comparative example 5, it is understood that since the content of water was 63%, not only was curling generated but there is a tendency for the gamut volume to be small and the coloring properties of the secondary colors not to be very favorable.

In addition, with regard to the ink set of comparative example 6, since the content of water was 48%, the clogging recoverability remarkably deteriorated.

The invention is not limited to the embodiments described above and various types of modifications are possible. For example, the invention includes configurations which are substantially the same as the configurations described in the embodiments (for example, configurations in which the functions, the methods, and the results are the same or configurations in which the purposes or the effects are the same). In addition, the invention includes configurations in which portions which are not intrinsic to the configurations described in the embodiments are replaced. In addition, the invention includes configurations which exhibit the same operational effects as the configurations described in the embodiments or configurations which are able to achieve the same purpose. In addition, the invention includes configurations where techniques known in the art are added to the configurations described in the embodiments.

The entire disclosure of Japanese Patent Application No. 2014-063298, filed Mar. 26, 2014 is expressly incorporated by reference herein.

What is claimed is:

1. An ink set comprising:
a yellow ink;
a magenta ink; and
a cyan ink,
wherein each of the inks contains a coloring agent which includes water and a pigment,
the coloring agent of the magenta ink and the cyan ink is a first coloring agent which has a phosphorus-containing group on a surface of the pigment,
the coloring agent of the yellow ink is a second coloring agent where a surface of the pigment is covered by a styrene-acryl resin, and
each of the inks contains 50 mass % or more to 60 mass % or less of water with respect to the total mass of the ink.

2. The ink set according to claim 1,
wherein a content of the pigment of the coloring agent of each of the inks in the ink set satisfies a relationship of 9 mass %≧magenta ink>yellow ink≧cyan ink≧5 mass %.

3. The ink set according to claim 1,
wherein the pigment which is contained in the yellow ink is C.I. Pigment Yellow 74,
the pigment which is contained in the magenta ink is a solid solution of C.I. Pigment Violet 19 and C.I. Pigment Red 202, and
the pigment which is contained in the cyan ink is C.I. Pigment Blue 15:3 or C.I. Pigment Blue 15:4.

4. The ink set according to claim 1,
wherein each of the inks in the ink set further contains 0.5 mass % or more to 5 mass % or less of at least one type of water-soluble organic solvent which is selected from a group formed of 1,2-alkanediol and glycol ether.

5. The ink set according to claim 1,
wherein each of the inks in the ink set further contains a first surfactant where an HLB value is 8 or greater and a second surfactant where an HLB value is less than 8.

6. The ink set according to claim 5,
wherein the first surfactant is an alkylene oxide adduct of acetylene glycol where a number of carbon atoms of a main chain is 12 or greater,
the second surfactant is acetylene glycol where a number of carbon atoms of a main chain is 10 or greater, and
each of the inks in the ink set contains 0.1 mass % or more to 1.0 mass % or less of each of the first surfactant and the second surfactant.
